(19) United States
(12) Patent Application Publication
(10) Pub. No.: US 2009/0171017 A1
(43) Pub. Date: Jul. 2, 2009

(54) CONTACT ADHESIVE CONTAINING N-BUTYLACRYLATE AND HYDROXYBUTYL(METH)ACRYLATE

(75) Inventors: Cornelis Petrus Beyers, Altrip (DE); Stefan Kirsch, Nieder-Olm (DE); Petra Schöcker, Bürstadt (DE); Ines Pietsch, Speyer (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/296,496

(22) PCT Filed: Apr. 16, 2007
(86) PCT No.: PCT/EP2007/053679

§ 371 Date: Oct. 8, 2008

(30) Foreign Application Priority Data
Apr. 28, 2006 (EP) 06113276.7

(51) Int. Cl. C08L 33/10

(52) U.S. Cl. 524/833

(57) ABSTRACT

A pressure-sensitive adhesive comprising an aqueous polymer dispersion prepared by emulsion polymerization, wherein the polymer comprises n-butyl(meth)acrylate and hydroxybutyl(meth)acrylate.

The invention relates to a pressure-sensitive adhesive comprising an aqueous polymer dispersion prepared by emulsion polymerization, wherein the polymer comprises n-butyl(meth)acrylate and hydroxybutyl(meth)acrylate.

The invention further relates to a process for the preparation of the pressure-sensitive adhesive and to its use.

With pressure-sensitive adhesives (PSAs) there is a desire not only for effective adhesion to the substrate but also for sufficient cohesion (internal strength) within the layer of adhesive. Adhesion and cohesion are divergent performance properties. Measures taken to improve adhesion generally lead at the same time to a deterioration in cohesion, and vice versa.

PSAs based on aqueous polymer dispersions which are obtainable by emulsion polymerization have been known for a long time. They include, in particular, polyacrylates. In emulsion polymers of this kind, an improvement in adhesion and cohesion has to date been achieved through selection of suitable comonomers or additives. By way of example, reference may be made to DE-A 103 23 048, whereby positive effects are obtained by adding silicon compounds to the polymer dispersion. EP-A 625 557 discloses PSAs comprising hydroxyalkyl acrylates.

Self-adhesive articles are composed essentially of a backing applied to which there is a layer of pressure-sensitive adhesive. For many applications the backing is transparent. Water exposure is often accompanied by the phenomenon known as “blushing”, by which is meant a clouding in the adhesive layer caused by water penetration. This blushing detracts from the performance properties; naturally, it is in the case of transparent film-backed labels in particular that the clouding adversely affects the visual appearance.

EP-A 1 378 527 or WO 98/44064, for example, discloses lessening the blushing in the case of aqueous polymer dispersions by means of specific synthesis components of the dispersed polymer. The result achieved is still not entirely satisfactory.

The objects of the present invention were, therefore, reduced blushing and good performance properties of the pressure-sensitive adhesive. In particular the pressure-sensitive adhesives should have good adhesion and/or cohesion.

It is to this effect that the invention provides the pressure-sensitive adhesive defined at the outset. A process for its production is also provided.

As a major constituent, the pressure-sensitive adhesive comprises an aqueous polymer dispersion which is prepared by emulsion polymerization; the dispersed polymer is therefore an emulsion polymer.

The emulsion polymer is composed preferably of at least 40%, more preferably at least 50%, and very preferably at least 60% by weight of n-butyl acrylate or n-butyl methacrylate (n-butyl(meth)acrylate for short); n-butyl acrylate is preferred.

In particular, the content of n-butyl(meth)acrylate is at most 99.9% by weight, particularly 99% by weight.

In addition to n-butyl(meth)acrylate, the emulsion polymer can comprise further, so-called principal monomers, selected from C1-C20 alkyl(meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds, or mixtures of these monomers.

Examples include (meth)acrylic acid alkyl esters having a C1-C10 alkyl radical, such as methyl methacrylate, methyl acrylate, ethyl acrylate, and 2-ethylhexyl acrylate.

Vinyl esters of carboxylic acids having 1 to 20 carbon atoms are, for example, vinyl laurate, vinyl stearate, vinyl propionate, Versatic acid vinyl esters, and vinyl acetate.

Suitable vinylaromatic compounds include vinyltoluene, a- and p-methylstyrene, a-butylstyrene, 4-n-butylstyrene, 4-n-decylstyrene, and, preferably, styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Examples of vinyl ethers include vinyl methyl ether or vinyl isobutyl ether. Preference is given to vinyl ethers of alcohols comprising 1 to 4 carbon atoms.

Hydrocarbons having 2 to 8 carbon atoms and one or two olefinic double bonds include ethylene, propylene, butadiene, isoprene, and chloroprene.

Preferred principal monomers are the C1 to C10 alkyl acrylates and methacrylates, especially C1 to C8 alkyl acrylates and methacrylates, and vinylaromatics, especially styrene, and mixtures thereof.

Very particularly preferred further principal monomers are methyl acrylate, methyl methacrylate, ethyl acrylate, 2-ethylhexyl acrylate, n-hexyl acrylate, styrene, and mixtures of these monomers.

The emulsion polymer may be composed for example of 0% to 40%, especially 0% to 30%, by weight of further principal monomers of this kind.

In accordance with the invention the polymer necessarily comprises, besides the n-butyl(meth)acrylate, hydroxybutyl acrylate or hydroxybutyl methacrylate (hydroxybutyl(meth)acrylate for short). The butyl chain of the hydroxybutyl(meth)acrylate is preferably unbranched, and is an n-butyl chain. The OH group is located preferably on the terminal C atom, and the compound is therefore 4 hydroxy-n-butyl (meth)acrylate. Particular preference is given to the acrylates over the methacrylates; very particular preference is given to 4 hydroxy-n-butyl acrylate.

The amount of the hydroxybutyl(meth)acrylate comprised in the polymer is preferably at least 0.1%, more preferably at least 0.3%, very preferably at least 0.5%, and in particular at least 1% by weight. The amount of hydroxybutyl(meth)acrylate comprised in the polymer is generally not greater than 5%, more preferably not greater than 4.5%, and in particular not greater than 3% by weight. All of these weight figures are based on the polymer.

Besides the n-butyl(meth)acrylate, the hydroxybutyl(meth)acrylate, and, if appropriate, the principal monomers above it is possible for the polymer to comprise what are called auxiliary monomers, examples being monomers containing acid groups (acid monomers; see above), e.g., carboxylic acid, sulfonic acid or phosphonic acid groups. Carboxylic acid groups are preferred. Examples that may be mentioned include acrylic acid, methacrylic acid, itaconic acid, maleic acid, and fumaric acid.

Further examples of auxiliary monomers include other monomers comprising hydroxyl groups, especially C1-C10 hydroxyalkyl(meth)acrylates, or (meth)acrylamide.

Further auxiliary monomers that may be mentioned include phenyloxyethyl glycol mono(meth)acrylate, glycidyl acrylate, glycidyl methacrylate, and amino (meth)acrylates such as 2-aminoethyl(meth)acrylate.

As auxiliary monomers mention may also be made of crosslinking monomers.

In particular the polymer can comprise acid monomers, preferably in amounts of 0.1% to 5%, more preferably 0.2% to 4%, very preferably 0.5% to 3% by weight, based on the polymer.

One preferred polymer is constructed for example as follows:

40% to 98% by weight n-butyl(meth)acrylate (BA)
0.1% to 5% by weight hydroxybutyl(meth)acrylate (HBA)
1% to 30% by weight further principal monomers (see above)
0% to 5% by weight auxiliary monomers, especially acid monomers

One particularly preferred polymer is constructed for example as follows:

50% to 95% by weight n-butyl(meth)acrylate (BA)
0.2% to 4% by weight hydroxybutyl(meth)acrylate (HBA)
4% to 30% by weight further principal monomers (see above)
0.2% to 5% by weight auxiliary monomers, especially acid monomers

One very particularly preferred polymer is constructed for example as follows:

60% to 90% by weight n-butyl(meth)acrylate (BA)
0.5% to 4% by weight hydroxybutyl(meth)acrylate (HBA)
5% to 30% by weight further principal monomers (see above)
0.2% to 5% by weight auxiliary monomers, especially acid monomers

The glass transition temperature of the polymer is preferably −60 to 0° C., more preferably −60 to −10° C., and very preferably −60 to −20° C.

The glass transition temperature can be determined by typical methods such as differential thermoanalysis or differential scanning calorimetry (see, e.g., ASTM 3418/82, midpoint temperature).

The preparation of the polymers takes place by emulsion polymerization; the polymer is therefore an emulsion polymer.

Emulsion polymerization involves polymerizing ethylenically unsaturated compounds (monomers) in water using ionic and/or nonionic emulsifiers and/or protective colloids or stabilizers as surface-active compounds to stabilize the monomer droplets and the polymer particles formed subsequently from the monomers.

A detailed description of suitable protective colloids is found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers. As surface-active substances it is preferred to use emulsifiers, whose molecular weights, unlike those of the protective colloids, are typically below 2000 g/mol. Where mixtures of surface-active substances are used the individual components must, as will be appreciated, be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO degree: 3 to 50, alkyl radical: C₈ to C₃₆), ethoxylated mono-, di-, and trialkylphenols (EO degree: 3 to 50, alkyl radical: C₄ to C₉), alkali metal salts of dialkyl esters of sulfosuccinic acid and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula II

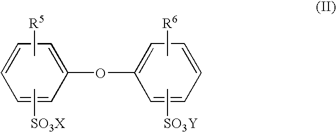

in which R5 and R6 are hydrogen or C4 to C14 alkyl and are not simultaneously hydrogen, and X and Y can be alkali metal ions and/or ammonium ions. Preferably R5 and R6 are linear or branched alkyl radicals having 6 to 18 carbon atoms or hydrogen, and in particular having 6, 12 and 16 carbon atoms, R5 and R6 not both simultaneously being hydrogen. X and Y are preferably sodium, potassium or ammonium ions, with sodium being particularly preferred. Particularly advantageous compounds II are those in which X and Y are sodium, R5 is a branched alkyl radical having 12 carbon atoms, and R6 is hydrogen or R5. It is common to use technical mixtures having a fraction of 50% to 90% by weight of the monoalkylated product, an example being Dowfax [symbol] 2A1 (trade mark of the Dow Chemical Company).

Suitable emulsifiers are also found in Houben-Weyl, Methoden der organischen Chemie, Volume 14/1, Makromolekulare Stoffe, Georg Thieme Verlag, Stuttgart, 1961, pages 192 to 208.

Emulsifier trade names are, for example, Dowfax [symbol] 2 A1, Emulan [symbol] NP 50, Dextrol [symbol] OC 50, Emulgator 825, Emulgator 825 S, Emulan [symbol] OG, Texapon [symbol] NSO, Nekanil [symbol] 904 S, Lumiten [symbol] I-RA, Lumiten E 3065, Disponil FES 77, Lutensol AT 18, Steinapol VSL, Emulphor NPS 25.

The surface-active substance is used typically in amounts of 0.1 to 10% by weight, based on the monomers to be polymerized.

In the emulsion polymerization use is made typically of water-soluble initiators for the free-radical polymerization of the monomers.

Water-soluble initiators for emulsion polymerization are, for example, ammonium salts and alkali metal salts of peroxydisulfuric acid, e.g., sodium peroxodisulfate, hydrogen peroxide or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing components comprise, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of typical redox initiator systems include ascorbic acid/iron(II) sulfate/sodium peroxydisulfate, tert-butyl hydroperoxide/sodium disulfite, tert-butyl hydroperoxide/Na-hydroxymethanesulfinic acid. The individual components, the reducing component for example, may also be mixtures: for example, a mixture of the sodium salt of hydroxymethanesulfinic acid and sodium disulfite.

The stated compounds are mostly used in the form of aqueous solutions, the lower concentration being determined by the amount of water that is acceptable in the dispersion and the upper concentration by the solubility of the respective compound in water. In general the concentration is 0.1 to 30% by weight, preferably 0.5 to 20% by weight, more preferably 1.0 to 10% by weight, based on the solution.

The amount of the initiators is generally 0.1 to 10% by weight, preferably 0.5 to 5% by weight, based on the monomers to be polymerized. It is also possible for two or more different initiators to be used for the emulsion polymerization.

In the course of the polymerization, polymerization regulators, regulators for short, can also be used in accordance with the invention. Regulators bring about a chain termination reaction and hence reduce the molar weight of the polymer. In the course of this reaction the regulators are attached to the polymer, generally to the chain end.

The amount of regulators can be, for example, 0.05 to 4 parts by weight, more preferably 0.05 to 0.8 part by weight, and very preferably 0.1 to 0.6 part by weight, based on 100 parts by weight of the monomers to be polymerized. Suitable regulators are, in particular, compounds having a mercapto group, such as tert-butyl mercaptan, thioglycolic acid ethylacrylic esters, mercaptoethynol, mercaptopropyltrimethoxysilane or tert-dodecyl mercaptan. The regulators are generally low molecular weight compounds having a molar weight of less than 2000, in particular less than 1000 g/mol.

The emulsion polymerization takes place in general at 30 to 130, preferably 50 to 90° C. The polymerization medium may be composed either of water alone or of mixtures of water and water-miscible liquids such as methanol. Preferably only water is used. The feed process may be conducted as a staged or gradient procedure. Preference is given to the feed process, in which a portion of the polymerization mixture is introduced as an initial charge and heated to the polymerization temperature, the polymerization of this initial charge is commenced, and then the remainder of the polymerization mixture is supplied to the polymerization zone, typically by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial polymerization charge.

The manner in which the initiator is added to the polymerization vessel in the course of the free-radical aqueous emulsion polymerization is known to the average skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

A portion of the monomers can, if desired, be included in the initial charge to the polymerization vessel at the beginning of the polymerization; the remaining monomers, or all the monomers if no monomers are included in the initial charge, are added in the feed process in the course of the polymerization.

The regulator as well can be included in part in the initial charge, or added in whole or in part during the polymerization or toward the end of the polymerization.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81 083), by adding excess quantities of emulsifier, or by adding miniemulsions. Another advantage associated with the low viscosity at high solids content is the improved coating behavior at high solids contents. One or more new generations of particles can be produced at any point in time. This point in time depends on the particle size distribution which is targeted for a low viscosity.

The monomers are added at least partly during the polymerization continuously. In part it is also possible to include monomers in the initial charge to the polymerization vessel before the beginning of the polymerization.

Preferably not more than 30% by weight of the total amount of monomers, more preferably not more than 20%, and very preferably not more than 10% by weight of the monomers is included in the initial charge to the polymerization vessel. The remaining monomers, i.e., preferably at least 70%, more preferably at least 80%, and very preferably at least 90% by weight, are added continuously during the polymerization. In one particular embodiment no monomers are included in the initial charge—in other words, the entirety of the monomers is run in during the polymerization.

The individual components can be added to the reactor in the case of the feed process from the top, through the side, or from below, through the reactor floor.

In one preferred embodiment the hydroxybutyl(meth)acrylate is added to the polymerization mixture completely or at least partly not until toward the end of the emulsion polymerization.

In particular more than 60% by weight of the hydroxybutyl(meth)acrylate (referred to below for short as the residual amount of HBA) is not supplied, in the emulsion polymerization, until the polymerization mixture (mixture present in the polymerization vessel and consisting of monomers and of polymer that has already formed) already contains more than 50%, more preferably more than 60%, very preferably more than 75%, by weight of the total amount of the monomers.

In all figures which refer to the polymerization mixture, the term “monomer” is to be taken to refer not only to monomers which have not yet undergone polymerization but also to monomer units of the polymer, i.e., the copolymerized monomers.

The above residual amount of HBA is in particular at least 70%, more preferably at least 80%, and very preferably at least 90% by weight, or 100% by weight, of the hydroxybutyl(meth)acrylate.

With very particular preference the residual amount of HBA is supplied at the end of the emulsion polymerization, in other words after all other monomers have already been supplied to the polymerization mixture.

At the beginning of the addition of the residual amount of HBA the monomers added to the polymerization mixture have preferably already predominantly undergone polymerization; in other words, at the beginning of the addition of the residual amount of HBA, at least 40% by weight of the polymerization mixture is composed of polymer which has already formed.

For the purpose of removing the residual monomers it is also possible to add further initiator after the end of the actual emulsion polymerization, in other words after the conversion of all of the monomers and after copolymerization of the residual amount of HBA (chemical deodorization).

In the case of the emulsion polymerization, aqueous polymer dispersions with solids contents of generally 15% to 75% by weight, preferably of 40% to 75% by weight, are obtained.

The polymer thus prepared is used preferably in the form of its aqueous dispersion.

The polymer is preferably used as or in pressure-sensitive adhesives (PSAs).

The PSA comprises the polymer preferably in the form of the aqueous polymer dispersion as has been obtained, or is obtainable, by emulsion polymerization.

The PSA may be composed exclusively of the polymer, or of the aqueous dispersion of the polymer.

Alternatively the PSA may comprise further additives.

Suitable examples include a tackifier, i.e., a tackifying resin. Tackifiers are known for example from Adhesive Age, July 1987, pages 19-23 or Polym. Mater. Sci. Eng. 61 (1989), pages 588-592.

Tackifiers are, for example, natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. These polyacrylates preferably have a weight-average molecular weight M_{w} of below 30 000. The polyacrylates with preference are composed of at least 60%, in particular at least 80% by weight of C₁-C₈ alkyl(meth)acrylates.

Preferred tackifiers are natural or chemically modified rosins. Rosins are composed predominantly of abietic acid or abietic acid derivatives.

The tackifiers can be added in a simple way to the polymers of the invention, preferably to the aqueous dispersions of the polymers. In this case the tackifiers are preferably themselves in the form of an aqueous dispersion.

The amount by weight of tackifiers is preferably 5 to 100 parts by weight, more preferably 10 to 50 parts by weight, based on 100 parts by weight of polymer (solids/solids).

Besides tackifiers, for example, further additives may find use, examples being thickeners, preferably associative thickeners, defoamers, plasticizers, pigments, wetting agents or fillers, in the case of the PSA utility.

Accordingly the PSAs of the invention further comprise, in addition to the aqueous polymer dispersion, if appropriate, tackifiers and/or the above additives.

For improved surface wetting the PSAs may comprise, in particular, wetting assistants, examples being fatty alcohol ethoxylates, alkylphenol ethoxylates, sulfosuccinic esters, nonylphenol ethoxylates, polyoxyethylenes/-propylenes or sodium dodecylsulfonates. The amount is generally 0.05 to 5 parts by weight, in particular 0.1 to 3 parts by weight, per 100 parts by weight of polymer (solids).

The PSAs are suitable for producing self-adhesive articles such as labels, sheets or adhesive tapes. The PSA can be applied by typical methods, such as for example by rolling, knifecoating, spreading, etc., to backings, examples being paper or polymeric films, composed preferably of polyethylene, polypropylene, which may have been biaxially or monoaxially oriented, polyethylene terephthalate, polyvinyl chloride, polystyrene, polyamide or metal. Also suitable in particular are backings having nonpolar surfaces, made for example of polyolefins, especially polyethylene or polypropylene, since the dispersions of the invention adhere well to such backings.

In particular, transparent backings—for example, transparent polymer sheets—are also possible. Self-adhesive articles with transparent polymer sheets are, for example, film-backed labels.

The water can be removed preferably by drying at 50 to 150° C. Before or after the adhesive is applied the backings may be slit to form adhesive tapes, labels or sheets. For subsequent use the PSA-coated side of the substrates may be lined with a release paper, e.g., with a siliconized paper.

The self-adhesive articles of the invention have very good adhesive properties, in particular an effective adhesion to the substrates and a high level of cohesion (internal strength in the adhesive layer). They also enjoy effective adhesion to apolar surfaces and are therefore particularly suitable not least for substrates having apolar surfaces, e.g., polyolefin surfaces, e.g., polyethylene (HDPE or LDPE) or polypropylene.

In particular the PSAs of the invention are suitable also for transparent backings, in particular not least for film-backed labels, since the “blushing” that frequently occurs on water exposure does not occur, or is at least lessened. Consequently the performance properties are effectively retained even on water exposure; there is no—or virtually no—clouding or other impairment of the visual appearance observed.

### EXAMPLES

### Preparation of the Polymer Dispersions

In a 2-liter polymerization reactor with anchor stirrer and heating/cooling apparatus a mixture of 102.61 g of deionized water and 8.33 g of a 33% strength by weight aqueous polymer latex (prepared by free-radically initiated emulsion polymerization of styrene) having a weight-average particle diameter Dw50 of 30 nm was heated at 85° C. under a nitrogen atmosphere. Added to this mixture at the aforementioned temperature are 4.71 g of a 7% strength by weight aqueous solution of sodium peroxodisulfate. After 2 minutes, feed streams 1 and 2 are started and are metered in at a uniform rate over 3 h.

Feed stream 1 was an aqueous emulsion prepared from

| | | |
|---|---|---|
| 271.84 | g | deionized water |
| 18.33 | g | a 30% strength by weight aqueous solution of Disponil |
| | | FES 77 (ethoxylated C12-C14 Na sulfate) |
| 1.9 | g | a 58% strength by weight aqueous solution of Lumiten |
| | | I-SC (succinic ester) |
| 364.38 | g | n-butyl acrylate |
| 122.38 | g | ethyl acrylate |
| 12.38 | g | styrene |
| 27.5 | g | methyl acrylate |
| 11.00 | g | acrylic acid |

Feed stream 2 was 47.14 g of a 7% strength by weight aqueous solution of sodium peroxodisulfate.

Feed stream 3 is started after 120 minutes and metered in over 60 minutes.

Feed stream 3 was 12.38 g of either 2-hydroxyethyl acrylate or 2-hydroxypropyl acrylate or 4-hydroxybutyl acrylate.

After the end of feed streams 1, 2 and 3, stirring was carried out for 30 minutes. Subsequently feed streams 4 and 5 were commenced and were metered in at a uniform rate over 60 minutes.

Feed stream 4 was 5.5 g of a 10% strength by weight aqueous solution of tert-butyl hydroperoxide.

Feed stream 5 was 7.33 g of a 12% strength by weight aqueous solution of sodium acetone disulfite.

After the end of feed streams 5 and 6, the internal temperature of the reactor was lowered to 25° C. The aqueous polymer dispersion obtained had a solids content of 53.5% by weight. The average particle size was 200 nm.

TABLE 1
Composition of the polymers

| | Comparative | Comparative | Inventive |
|---|---|---|---|
| | example 1 (C1) | example 2 (C2) | example (B1) |
| Acrylic acid | 2 | 2 | 2 |
| Styrene | 2.25 | 2.25 | 2.25 |
| Methyl acrylate | 5 | 5 | 5 |
| Ethyl acrylate | 22.5 | 22.5 | 22.5 |
| n-Butyl acrylate | 66.25 | 66.25 | 66.25 |
| Hydroxypropyl | 0 | 2.25 | 0 |
| acrylate (HPA) | | | |
| Hydroxyethyl | 2.25 | 0 | 0 |
| acrylate (HEA) | | | |
| Hydroxybutyl | 0 | 0 | 2.25 |
| acrylate (HBA) | | | |

### Performance Testing

Further Lumiten was added to the polymer dispersions, so that the amount of Lumiten was 1.2 parts by weight per 100 parts by weight of polymer (solids).

The pressure-sensitive adhesives were coated at a rate of 19 g/m² onto polyethylene film as backing (by the transfer method; coating first of silicone paper, and transfer to polyethylene) and were dried at 90° C. for 3 minutes.

This was followed by measurements of the loop tack (adhesion) and shear strength (cohesion).

The PSA-coated backing was cut into test strips 25 mm wide. To determine the shear strength, the test strips were adhered with a bonded area of 6.25 cm² to steel, rolled on once using a roller weighing 1 kg, stored for 10 minutes (under standard conditions; 50% relative humidity, 1 bar, 23° C.) and subsequently loaded in suspension with a 1 kg weight (under standard conditions). The measure of the shear strength was the time in hours taken for the weight to fall; the average was calculated from 5 measurements in each case.

For the determination of the loop tack, a loop was formed from a test strip measuring 17.5 cm long and 2.5 cm wide by the clamping of both ends into the clamping jaws of the tensile testing machine, and the loop was then contacted with a polyethylene surface at a speed of 300 mm/min (lowering of the loop onto the surface). After contact had been made over the full area, and after a contact time of 1 minute, the loop was removed again, and the maximum force measured in the course of this procedure was determined, in N/2.5 cm.

TABLE 2
Results

| | | Loop tack |
|---|---|---|
| | Shear strength | (N/2.5 cm) |
| Polymer | (hours) | on polyethylene |
| C1 | 59 | 3.6 |
| C2 | 47 | 3.7 |
| B1 | 64 | 4.2 |

1. A pressure-sensitive adhesive comprising an aqueous polymer dispersion prepared by emulsion polymerization, wherein the polymer comprises n-butyl (meth)acrylate and hydroxybutyl(meth)acrylate.

2. The pressure-sensitive adhesive according to claim 1, wherein the polymer is composed of at least 60% by weight of n-butyl(meth)acrylate.

3. The pressure-sensitive adhesive according to claim 1, wherein the polymer comprises in total 0.1% to 5% by weight of hydroxybutyl methacrylate.

4. The pressure-sensitive adhesive according to claim 1, wherein the polymer is obtainable by supplying more than 60% by weight of the hydroxybutyl(meth)acrylate (called residual amount of HBA below for short) during the emulsion polymerization only when the polymerization mixture (mixture present in the polymerization vessel and composed of monomers and polymer already formed) already comprises more than 50% by weight of the total amount of monomers.

5. The pressure-sensitive adhesive according to claim 1, wherein the residual amount of HBA is supplied only when the polymerization mixture (mixture present in the polymerization vessel and composed of monomers and polymer already formed) already comprises more than 75% by weight of the total amount of monomers.

6. The use of the pressure-sensitive adhesive according to claim 1 for producing self-adhesive articles.
